(19) United States
(12) Patent Application Publication
(10) Pub. No.: US 2008/0042819 A1
(43) Pub. Date: Feb. 21, 2008

(54) TIRE INFORMATION DETECTING DEVICE

(75) Inventor: Hideki Masudaya, Niigaka-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/740,718

(22) Filed: Apr. 26, 2007

(30) Foreign Application Priority Data
Apr. 28, 2006 (JP) 2006-124992

(51) Int. Cl. B60C 23/00

(52) U.S. Cl. 340/447

(57) ABSTRACT

A tire information detecting device accurately detects tire pressure and temperature. The device includes a transponder mounted in a tire of a vehicle, and a controller located in the vehicle body. The transponder includes a diode, which modulates and demodulates a signal transmitted to and received from the controller, and a pressure measuring unit, which measures a tire pressure. Also included is a detecting resonance circuit connected between the diode and the pressure measuring unit, which resonates in accordance with a signal from the controller. A resonance circuit resonates in accordance with the signal from the controller and controls a connection between the pressure measuring unit and the detecting resonance circuit.

This application claims the benefit of priority under 35 U.S.C. §119 to Japanese Patent Application No. 2006-124992, filed Apr. 28, 2006, and is hereby incorporated by reference in its entirety.

### BACKGROUND OF THE INVENTION

1. Field of the Invention

The present invention relates to a tire information detecting device, and more particularly, to a tire information detecting device capable of detecting tire information, including tire pressure and tire temperature.

2. Description of the Related Art

Known radio transmission devices wirelessly transmit and estimate measured values, such as a tire pressure, to a controller disposed in a vehicle for the purpose of providing an alarm message for a driver. This is suggested in FIGS. 5 and 6 of U.S. Pat. No. 6,378,360 B1. In such the radio transmission device, a controller (FIG. 5) is provided in the main body of the vehicle, and a measured value transmitter (FIG. 6) is provided inside the tire.

As shown in FIG. 5, the controller includes a carrier oscillator G1 generating a carrier wave (f1) of 2.4 GHz, a modulator MO1, and an oscillator G2 outputting a modulation oscillation signal. The oscillator G2 outputs a oscillation signal of frequency (f2), which is similar to a resonance frequency of a resonator of a transponder. A carrier wave from the oscillator G1 is amplitude-modulated by the oscillation signal of the oscillator G2, and an amplitude-modulated high-frequency signal of 2.4 GHz is amplified by an amplifier (not shown), so that it is radiated from an antenna.

Additionally, the controller includes a switch S1, which switches an amplitude modulation by the modulator MO1, a receiver E1, which receives a high-frequency signal radiated from the transponder and calculates a measured value (V1) of a tire pressure, and a timer T1, which controls a switching time of the switch S1 and a state of the receiver E1. An amplitude modulation of the carrier wave is switched by the timer T1, and then for a certain period of time, the amplitude-modulated high-frequency signal is transmitted so that a non-modulated carrier wave is transmitted when the amplitude modulation is stopped at a time point t1. The receiver E1 becomes active at a time point t2 prior to a time= t1 by about 1 ms, and receives a high-frequency signal via an antenna A4 from the transponder.

As shown in FIG. 6, the transponder includes a low-pass filter L1/C1, a varactor diode D1 (hereinafter, a diode) which functions as a modulator and demodulator, a capacitive pressure sensor SC1, which varies with the tire pressure, and a resonator having a quartz-crystal resonator Q1, which is excited by a frequency component included in a high-frequency signal from the controller. In the high-frequency signal from the controller, the carrier wave of 2.4 GHz is removed by the low-pass filter L1/C1 and demodulated by the diode D1. Accordingly, a signal, which is the same as the oscillation signal of the oscillator G2, is extracted. Because the resonance frequency of the resonator is similar to the oscillation signal of the oscillator G2, the resonance frequency is excited by a signal generated therefrom. According to such the excitation, the resonance-frequency signal occurs. Additionally, in the resonance frequency of the resonator, since a capacity of the capacitive pressure sensor SCI varies with the tire pressure, the resonance-frequency signal occurring therefrom is influenced by the effect.

As described above, after the controller transmits the amplitude-modulated high-frequency signal, the controller stops the amplitude modulation and transmits a non-modulated carrier wave. The resonator continuously oscillates for about 1 ms or more even when the amplitude modulation is stopped. Accordingly, the non-modulated carrier wave from the controller is amplitude-modulated with the resonance-frequency signal of the resonator by the diode D1 and then radiated from an antenna A3. In the receiver E1, the amplitude-modulated high-frequency signal is received via an antenna A4 and the resonance-frequency signal is extracted via a demodulator (not shown) so that it is possible to calculate the measured value (V1) of the tire pressure.

In the radio transmission device disclosed in U.S. Pat. No. 6,378,360 B1, a plurality of resonators are additionally disposed in transponders. It is possible to transmit the signal of measured values of the tire temperature and calculate the measured value in the controller.

However, in such known radio transmission devices, when multiple resonators are located in a transponder and multiple measured values of a tire pressure, tire temperature, and the like are detected, a temperature characteristic or a temporal degradation characteristic of each of the resonators is different from each other, and thus an error occurs in the measured value. Therefore, the measured value is not detected accurately.

Specifically, when the tire pressure is measured, a resonance frequency of a resonator for measuring a pressure is influenced by both a pressure and a temperature, whereby the temperature value is obtained from the resonance frequency of the resonator for measuring a temperature in the other side. Although the pressure is obtained without the temperature influence by using the temperature value, when the temperature characteristic or the temporal degradation characteristic of both of the resonators is different from each other, it is impossible to accurately perform the correction.

### SUMMARY OF THE INVENTION

The present invention solves the above-mentioned problems. It is an object of the invention to provide a tire information detecting device capable of accurately detecting the multiple measured values, including tire pressure and tire temperature.

According to an aspect of the invention, there is provided a tire information detecting device including a measured value transmitter mounted on a tire of a vehicle, and a controller disposed on a main body of the vehicle so as to transmit and receive a signal to and from the measured value transmitter. The measured value transmitter includes an antenna, a modulator and a demodulator used to transmit and receive signal to and from the controller, a pressure measuring unit for measuring a tire pressure, a detecting resonance circuit connected between the modulator and the pressure measuring unit, which resonates in accordance with the signal from the controller, a connecting resonance circuit, which oscillates in accordance with the signal from the controller, and a control circuit for controlling a connection between the pressure measuring unit and the detecting resonance circuit.

According to the above-described configuration, a connection between the pressure measuring unit and the detecting resonance circuit is controlled in accordance with a signal from the controller. Accordingly, the connection between the detecting resonance circuit and the pressure measuring unit is switched, whereby the resonance frequency of the detecting resonance circuit is estimated depending on the respective situation by using the controller, whereby plural resonance circuits, for example, quartz-crystal resonators, are not necessary. Thus, a single detecting resonance circuit can calculate both a tire temperature and a tire pressure, thereby accurately detecting the tire pressure and the tire temperature. In addition, the connection between the pressure measuring unit and the detecting resonance circuit is controlled with the resonance of the connecting resonance circuit in the control circuit, whereby the resonance of the connecting resonance circuit is controlled by the controller, thereby controlling the connection between the pressure measuring unit and the detecting resonance circuit.

The control circuit may include a switching element, which is connected to an input-output terminal of the pressure measuring unit in a first signal line. The switching element enters an ON state so as to connect the pressure measuring unit to the detecting resonance circuit with the resonance of the connecting resonance circuit. Additionally, it is preferable that the switching element enters an OFF state so as to disconnect the pressure measuring unit from the detecting resonance circuit because the connecting resonance circuit does not resonate. In this case, the resonance of the connecting resonance circuit is controlled by the controller so that an ON and OFF state of the switching element is switched and it is possible to control the connection between the pressure measuring unit and the detecting resonance circuit.

The measured value transmitter may transmit a signal of the resonance frequency of the detecting resonance circuit to the controller as the switching element is an OFF state. Additionally, it is possible to transmit a signal of the resonance frequency of the detecting resonance circuit to the controller as the switching element is an OFF state. In this case, since the resonance frequency, which is transmitted to the controller varies in accordance with the ON and OFF of the switching element, it is possible for a single detecting resonance circuit to calculate the tire temperature and the tire pressure by estimating such the resonance frequency.

The measured value transmitter may include a second signal line, which bypasses the first signal line between the input-output terminal of the pressure measuring unit side and the input-output terminal. In this case, the ON and OFF state of the switching element can be switched by the connecting the resonance circuit to the second signal line, whereby this does not influence a signal which communicates via the first signal line, thereby controlling the connection between the pressure measuring unit and the detecting resonance circuit.

The connecting resonance circuit may be an LC resonance circuit. In this case, it is possible to reduce cost. Additionally, the resonance circuit may be a piezoelectric resonator.

The switching element may be a diode. In this case, it is possible to reduce the cost of the switching element. In addition, the switching element can be an FET.

The controller may transmit a signal which enables the detecting resonance circuit and the connecting resonance circuit to resonate to the measured value transmitter. Additionally, the resonance-frequency signal of the detecting resonance circuit and the resonance-frequency signal of the detecting resonance circuit are received from the measured value transmitter, and the tire temperature and the tire pressure may be calculated in accordance with the resonance frequency of the detecting resonance circuit extracted from the received signal. In this case, it is possible to calculate both the tire temperature and the tire pressure by using a single detecting resonance circuit, thereby accurately detecting the tire pressure and the tire temperature.

The controller may calculate the tire temperature in accordance with a difference in frequency between a frequency of a signal which enables the detecting resonance circuit to resonate, and the resonance frequency which is extracted from the received signal in accordance with the signal.

The controller may calculate the tire pressure in accordance with a difference in frequency between the resonance frequency extracted from the received signal, and the resonance frequency extracted from the received signal in accordance with a signal which enables the detecting resonance circuit to resonate in accordance with the measurement result of the pressure measuring unit. Accordingly, it is possible to calculate the tire pressure except for a temperature influence by using single detecting resonance circuit, thereby more accurately detecting the pressure.

The detecting resonance circuit may include the quartz-crystal resonator. In this case, an oscillation of a resonance signal becomes stable, and thus it is possible to detect the tire temperature and the tire pressure in a stable manner.

According to the above-mentioned configurations, it is possible to more accurately detect multiple measured values, including tire pressure and tire temperature.

### BRIEF DESCRIPTION OF THE DRAWINGS

FIG. 1 is a diagram illustrating a circuit configuration of a transponder constituting a tire information detecting device according to an embodiment of the invention.

FIG. 2 is a drawing illustrating a difference in frequency between a resonance frequency extracted from a received signal of the transponder, and a frequency of an osculation signal from a controller.

FIG. 3 is a chart illustrating a timing diagram.

FIG. 4 is a drawing illustrating a modified example of the circuit configuration of the transponder.

FIG. 5 is a schematic circuit configuration of a controller constituting the known tire information detecting device.

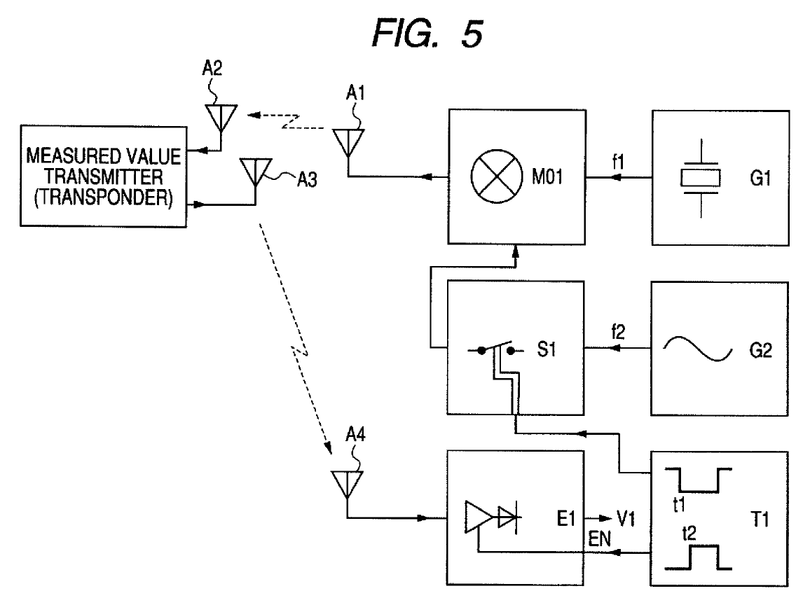

FIG. 6 is a schematic circuit configuration of a transponder constituting the known tire information detecting device.

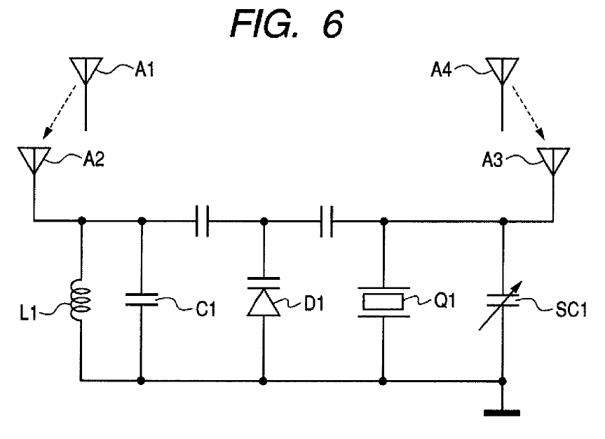

### DESCRIPTION OF THE PREFERRED EMBODIMENTS

Hereinafter, an embodiment of the invention will be described in detail with reference to the attached drawings. A tire information detecting device according to the embodiment includes a controller disposed on a main body of a vehicle, and a measured value transmitter (hereinafter, “transponder”) disposed inside a tire.

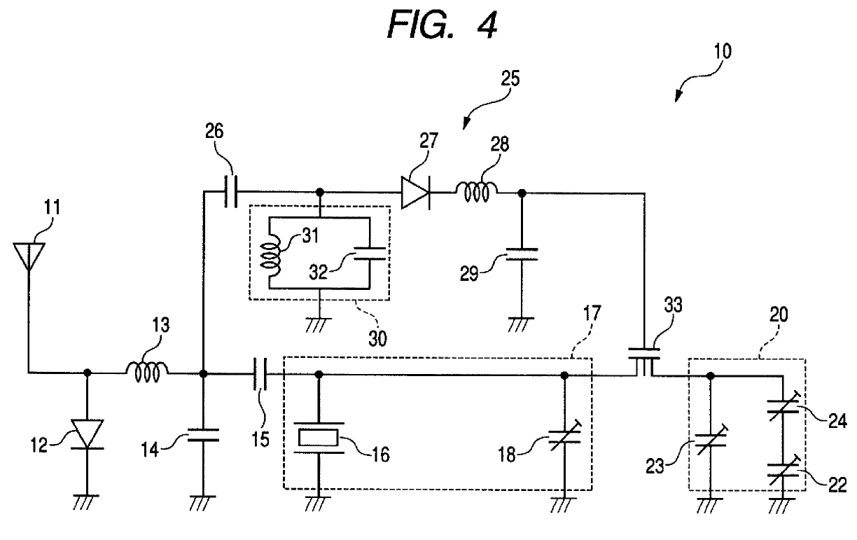

In the tire information detecting device according to the embodiment, a configuration of the transponder of the invention is different from that of the known tire information detecting devices. The difference with respect to the configuration of the controller will be described with reference to components shown in FIG. 4.

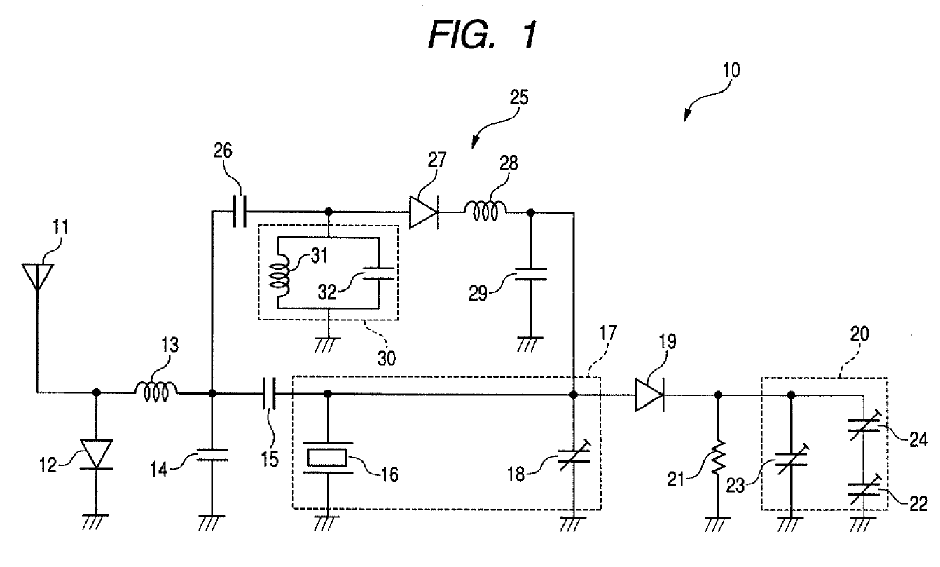

FIG. 1 is a diagram illustrating an example of a circuit configuration of the transponder constituting the tire information detecting device according to the embodiment.

As shown in FIG. 1, a transponder 10 includes an antenna 11 for a transmitting and receiving, and the antenna 11 is connected to a diode 12. In the diode 12, an anode is connected to an input-output terminal of the antenna 11, and additionally a cathode is connected to a ground. Meanwhile, one end of an inductor 13 is connected to the anode of the diode 12, and the other end thereof is connected to the ground, with a capacitor 14 disposed therebetween. Additionally, the inductor 13 and the capacitor 14 include a low-pass filter. The low-pass filter has a frequency characteristic so as to remove a carrier wave of 2.4 GHz. The diode 12 and the low-pass filter constitute a demodulator. The diode 12 functions as a modulator as well.

An end of the inductor 13 is connected to a quartz-crystal resonator 16, which detects tire temperature and tire pressure with a capacitor 15 disposed therebetween. One end of the quartz-crystal resonator 16 is connected to one side of an electrode of the capacitor 15, and the other end thereof is connected to the ground. A self-resonant frequency of the quartz-crystal resonator 16 is set at 9.800 MHz. In order to adjust resonance frequency of the quartz-crystal resonator 16, one side of an electrode of a variable capacitor 18 is connected to the quartz-crystal resonator 16, and the other side of the variable capacitor 18 is connected to the ground. The quartz-crystal resonator 16 and the variable capacitor 18 constitute a detecting resonance circuit 17.

One side of an electrode of the quartz-crystal resonator 16 is connected a pressure measuring unit 20 with a diode 19, which functions as a switching element, disposed therebetween. The pressure measuring unit 20 includes a pressure sensor 22 and two trimmer capacitors 23 and 24, which smooth a non-uniform detected result of the pressure sensor 22. The pressure sensor 22 includes a variable capacitor, where the capacitance varies in accordance with a detected pressure. In the diode 19, an anode is connected to one side of an electrode of the variable capacitor 18, and a cathode is connected to one end of a resistor 21 and one side of an electrode of the trimmer capacitors 23 and 24. The other end of the resistor 21 and the other side of an electrode of the trimmer capacitor 23 are connected to the ground. The other side of an electrode of the trimmer capacitor 24 is connected to the ground with the pressure sensor 22 disposed therebetween. The resistor 21 enables the diode 19 to be turned on.

The anode of the diode 19 is connected to a driving circuit 25, which enables the diode 19 to be turned on and off. The driving circuit 25 is disposed between one end of the inductor 13 and the anode of the diode 19 and is connected in parallel to the quartz-crystal resonator 16. In the driving circuit 25, one end of the inductor 13 is connected to a diode 27 with a capacitor 26 disposed therebetween. In a diode 27, an anode is connected to one side of an electrode of the capacitor 26, and a cathode is connected to one end of an inductor 28. The other end of the inductor 28 is connected to the ground with a capacitor 29 disposed therebetween. The inductor 28 and the capacitor 29 constitute a low-pass filter. The low-pass filter converts a resonance wave acquired from a resonance circuit 30 into a direct current.

In the driving circuit 25, a middle point between the capacitor 26 and the diode 27 is connected to the resonance circuit 30, which functions as a connecting resonance circuit. The resonance circuit 30 includes an inductor 31 and the capacitor 26, namely, an LC resonance circuit. The middle point is connected in parallel to one end of the inductor 31 and one side of an electrode of a capacitor 32, and additionally the other end of the inductor 31 and the other side of the electrode of the capacitor 32 are connected to the ground. A parallel resonance frequency 2 of the resonance circuit 30 is set to 10.800 MHz. The resonance frequency of the resonance circuit 30 can be modified if it does not resonate when the quartz-crystal resonator 16 resonates. When the resonance circuit 30 resonates, a signal of the resonance frequency is detected by the diode 27, and the capacitor 29 charges via the inductor 28. In addition, the driving circuit 25 and the diode 19 constitute a control circuit, which controls a connection of the pressure measuring unit 20 and the quartz-crystal resonator 16.

In the transponder, a resonance frequency of the quartz-crystal resonator 16 is changed in terms of the driving circuit 25 by switching the on and off state of the diode 19. Specifically, as the driving circuit 25 enables the diode 19 to be turned off, the quartz-crystal resonator 16 forms a resonance circuit together with the variable capacitor 18. As the diode 19 turns on, the quartz-crystal resonator 16 resonates in a state where the resonance circuit is connected to the pressure measuring unit 20. In the former, a resonance frequency of the quartz-crystal resonator 16 is influenced by only the tire temperature. On the other hand, in the latter, the resonance frequency of the quartz-crystal resonator 16 is influenced by not only the tire temperature but also the tire pressure. In the controller of the tire information detecting device according to the embodiment, a resonance of the resonance circuit 30 is controlled by switching a oscillation signal performing an amplitude modulation with respect to the carrier wave, whereby an on and off state of the diode 19 is switched so as to detect only the tire temperature or the tire pressure plus the tire temperature.

The controller according to the embodiment is different from the known tire information detecting devices (see FIG. 4). An oscillator G2 generates a oscillation signal of a frequency (f2) similar to the resonance frequency of the quartz-crystal resonator 16 and a oscillation signal of a frequency (f3) similar to the resonance frequency of the resonance circuit 30. An oscillation signal having a mean frequency of 9.800 MHz and a oscillation signal having a mean frequency of 10.800 MHz are generated, and the carrier wave (f1) is amplitude-modulated by those oscillation signals. In addition, a signal of which the carrier wave (f1) is amplitude-modulated forms a signal for allowing the quartz-crystal resonator 16 to resonate by using the former oscillation signal, and the signal of which the carrier wave (f1) is amplitude-modulated forms a signal for the purpose of allowing the resonance circuit 30 to resonate by using the latter oscillation signal.

In the controller according to the embodiment, it is same as the known controller where an amplitude modulation is switched by a switch S1. However, in the controller according to the embodiment, a time between an amplitude modulation by using the oscillation signal of the frequency (f2) and an amplitude modulation by using the oscillation signal of the frequency (f3), is switched. Specifically, an amplitude modulation of the carrier wave is performed by only the oscillation signal of the frequency (f2), and then the amplitude modulation is stopped at a time=t1 (FIG. 4). Accordingly, a non-modulated carrier wave is radiated. Amplitude modulation is then performed by the oscillation signals of both the frequency (f2) and the frequency (ft), and then the amplitude modulation by using the oscillation signal of the frequency (f2) is stopped at a time=t3 (not shown in FIG. 4). Accordingly, a high-frequency signal, which is amplitude-modulated by using the oscillation signal of the frequency (f3), is radiated. In addition, the reason that the non-modulated carrier wave is not is radiated is because it is necessary to maintain an ON state of the diode 19 by allowing the resonance circuit 30 to resonate when the tire pressure is measured.

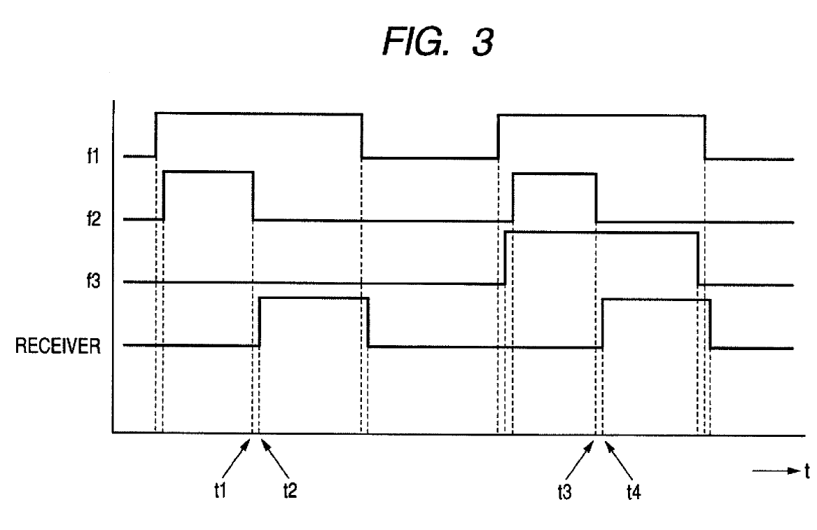

Next, an operational aspect of the invention will be described. When the tire temperature is measured, in the controller, the carrier wave (f1) of 2.4 GHz is amplitude-modulated by using the oscillation signal (having the mean frequency of 9.800 MHz) of the frequency (f2) generated by the oscillator G2. Then, the amplitude-modulated high-frequency signal is radiated from an antenna A1. At the time=t1 (FIG. 3), amplitude modulation is stopped, and at time=t2, a receiver E1 becomes active. Additionally, when the amplitude modulation is stopped, a non-modulated carrier wave is radiated from the antenna A1.

In the transponder 10, the high-frequency signal of 2.4 GHz, which is amplitude-modulated by using the controller, is detected by the diode 12, and also the carrier wave of 2.4 GHz is removed by the low-pass filter (coil 13 and capacitor 14). Accordingly, a oscillation signal, which is the same as the oscillation signal of the frequency (f2), is extracted. In the quartz-crystal resonator 16, the resonance frequency is similar to the frequency of the oscillation signal of the frequency (f2), and thus it is excited by the signal generated therefrom.

Accordingly, a resonance frequency of the quartz-crystal resonator 16 occurs. At this time, the resonance circuit 30 does not resonate due to the high-frequency signal from the controller, so the diode 19 remains in an OFF state. Because of this, the resonance frequency of the quartz-crystal resonator 16 is influenced by only the tire temperature.

In the controller, when an amplitude modulation is stopped and a non-modulated carrier wave is radiated, in the transponder 10, the quartz-crystal resonator 16 continuously oscillates for about 1 ms or less from when the amplitude modulation is stopped. Accordingly, the non-modulated carrier wave from the controller is amplitude-modulated by using the diode 12 in accordance with the resonance-frequency signal of the quartz-crystal resonator 16, and is radiated from die antenna 11. In the receiver E1 of the controller, the amplitude-modulated high-frequency signal is received via the antenna A4, and the tire temperature is calculated by extracting the resonance-frequency signal via a demodulator (not shown in the drawings).

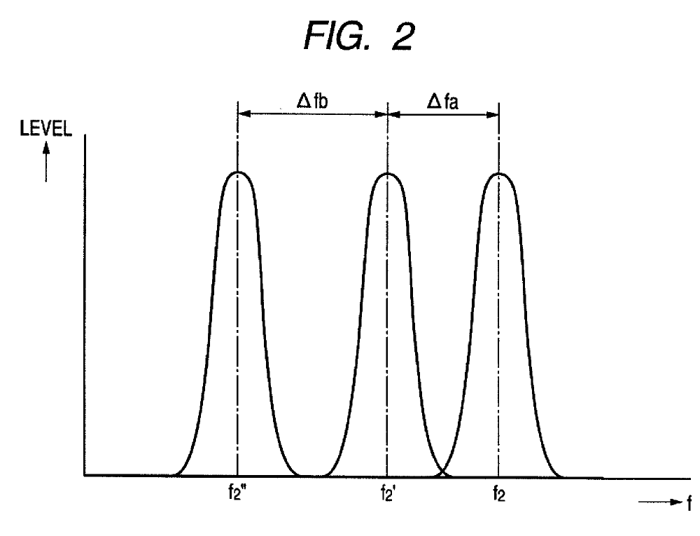

In the case where the tire temperature is calculated, in the receiver E1, a difference in frequency between the frequency (f2) of the oscillation signal generated from the oscillator G2 and a resonance frequency (f2) extracted from a received signal of the transponder 10, is estimated. When the tire temperature varies, a variation of the resonance frequency of the quartz-crystal resonator 16 varies, whereby a difference between the resonance frequency (f2′) and the frequency (f2′) which should be originally detected (Δfa shown in FIG. 2), is estimated. Therefore, it is possible to calculate the tire temperature by using the single quartz-crystal resonator 16.

In the case where the tire temperature is calculated, for example, a table illustrating a relationship between a resonance-frequency difference and the tire-temperature variation is preferably used in the calculation. Since the resonance frequency of the quartz-crystal resonator varies with a temperature, when a difference with the oscillation signal increases, an intensity of the received signal may decrease. At that time, it needs to change the frequency of the oscillation signal and measure it again.

When the tire pressure is measured, the carrier wave (f1) of 2.4 GHz is amplitude-modulated by the oscillation signal (mean frequency of 9.800 MHz) of the frequency (f2) and the oscillation signal (mean frequency of 10.800 MHz) of the frequency (f3), and then the amplitude-modulated high-frequency signal is radiated from the antenna A1. Then, at time=t3 (FIG. 3), amplitude modulation of the oscillation signal of the frequency (f2) is stopped, and at time= t4, the receiver E1 becomes active. Additionally, at the time of the amplitude modulation, by using the oscillation signal of the frequency (f2) is stopped, an amplitude-modulated high-frequency signal of 2.4 GHz is radiated from the antenna A1 by the oscillation signal of the frequency (f3).

When measuring the tire temperature, the high-frequency signal of 2.4 GHz, which is amplitude-modulated by using the controller, is detected by the diode 12, and also the carrier wave of 2.4 GHz is removed by the low-pass filter (coil 13 and capacitor 14). Accordingly, a oscillation signal which is the same as the oscillation signal of the frequency (f2) and the frequency (f3) is extracted.

In the resonance circuit 30, since the resonance frequency is similar to the oscillation signal of the frequency (f3), it is excited by the signal of the frequency (f3) extracted therefrom. Accordingly, the resonance-frequency signal of the resonance circuit 30 occurs. The resonance-frequency signal is detected by the diode 27, and is converted into a direct current by the low-pass filter (coil 28 and capacitor 29). Accordingly, the capacitor 29 charges. When the capacitor 29 charges to a predetermined level, the diode 19 enters an ON state. Accordingly, the quartz-crystal resonator 16 and the pressure measuring unit 20 are connected to each other, and the resonance frequency of the quartz-crystal resonator 16 which resonates in accordance with a signal of the same frequency as the oscillation signal of die extracted frequency (f2), is influenced not only by the tire temperature, but also by the tire pressure, which is detected by the pressure measuring unit 20.

In the controller, when the amplitude modulation is stopped by the oscillation signal of the frequency (f2) and the high-frequency signal, which is amplitude-modulated by the oscillation signal of the frequency (f3), is radiated from the antenna A1, the quartz-crystal resonator 16 continues to oscillate for about 1 ms or less from when the amplitude modulation due to the oscillation signal of the frequency (f2). Accordingly, the high-frequency signal, which is amplitude-modulated due to the oscillation signal of the frequency (f3), is amplitude-modulated by using the diode 12 in accordance with the resonance-frequency signal of the quartz-crystal resonator 16, and is radiated from the antenna 11. In the receiver E1 of the controller, the high-frequency signal is received via the antenna A4, and the tire pressure is calculated by extracting the resonance-frequency signal via the demodulator (not shown).

In the case where the tire pressure is calculated, in the receiver E1, the difference in frequency between the resonance frequency (f2′) extracted from the received signal out of the transponder 10 and a resonance frequency (f2″) extracted from a received signal out of the transponder 10, is estimated. When the diode 19 turns ON and the pressure measuring unit 20 is electrically connected to the quartz-crystal resonator 16, if the tire pressure varies, the resonance frequency of the quart-crystal resonator 16 also varies. Accordingly, as shown in FIG. 2, by estimating the difference (Δfb) between the resonance frequency (f2″) and the resonance frequency (f2′) detected when the tire temperature is calculated, it is possible to calculate the tire pressure by using the single quartz-crystal resonator 16.

For the purpose of estimation, the known procedure of which a correcting process to correct a portion of a temperature from the measured value can be omitted, the temperature characteristics and a temporal degradation characteristics of the respective quartz-crystal resonators, have little affect. Thus tire temperature and tire pressure can be calculated by using single quartz-crystal resonator 16.

In the case where the tire pressure is calculated, for example, a table illustrating a relationship between the resonance-frequency difference and the tire-pressure variation is prepared in advance. Since the resonance frequency of the quartz-crystal resonator varies with the temperature and the pressure, when a difference with the oscillation signal increases, the intensity of the received signal may decrease. At that time, the frequency of the oscillation signal is changed by small amount and is measure again.

In the transponder 10, the connection between the pressure measuring unit 20 and the quartz-crystal resonator 16 is controlled in accordance with the signal from the controller by means of a control circuit, which includes the driving circuit 25 and the diode 19. Accordingly, the connection between the quartz-crystal resonator 16 and the pressure measuring unit 20 is controlled, whereby a resonance frequency of the quartz-crystal resonator 16 is estimated by the controller. Thus, one quartz-crystal resonator 16 can calculate both the tire temperature and the tire pressure without multiple quartz-crystal resonators.

Additionally, in the driving circuit 25, as the resonance circuit 30 resonates, the connection between the pressure measuring unit 20 and the quartz-crystal resonator 16 is controlled, whereby the resonance of the resonance circuit 30 is controlled by the controller, thereby controlling the connection between the pressure measuring unit 20 and the quartz-crystal resonator 16.

The control circuit includes the diode 19, which is connected to an input-output terminal of the pressure measuring unit 20 on a first signal line in which the quartz-crystal resonator 16 and the pressure measuring unit 20 are connected to each other. Accordingly, an ON and OFF state of the diode 19 is switched in accordance with the resonance of the resonance circuit 30, thereby controlling the connection between the pressure measuring unit 20 and the quartz-crystal resonator 16.

The transponder 10 includes a second signal line, which bypasses the first signal line between the input-output terminal of the pressure measuring unit 20 side of the diode 12 on the first line and the input-output terminal of the diode 19, and is connected to an end of the resonance circuit 30 on the second signal line. Accordingly, the ON and OFF state of the diode 19 can be switched by the resonance circuit 30 of which an end thereof is connected to the second signal line, whereby this does not influence the signal which communicates via the first signal line, thereby controlling the connection between the pressure measuring unit 20 and the quartz-crystal resonator 16.

The invention is not limited to the above-described embodiment, and may be modified to various forms of the embodiment, if necessary. In the above-described embodiment, the circuit configuration or the like as shown in the attached drawings is not limited to the above-described embodiment, and may be modified.

For example, in the tire information detecting device according to the above-described embodiment, the transponder includes an LC resonance circuit, which is connected in parallel to the quartz-crystal resonator 16 to form the resonance circuit 30. But the resonance circuit which is connected in parallel to the quartz-crystal resonator 16, is not limited to this configuration. For example, the LC resonance circuit may be replaced with a piezoelectric resonator. However, for reasons of cost, the LC resonance circuit as the above-described embodiment may be utilized.

In addition, in the tire information detecting device according to the above-described embodiment, the diode 19 is used as a switching element which switching the connection between the quartz-crystal resonator 16 and the pressure measuring unit 20. However, the switching element is not limited to this configuration. For example, the diode 19 may be replaced with an FET.

Although the detecting resonance circuit comprises the quartz-crystal resonator, the detecting resonance circuit is not limited to this configuration, and may be replaced with a piezoelectric single crystal resonator, made of a single piezoelectric crystal formed of a lithium tantalite (LiTaO₃), a lithium niobate (LiNbO₃), a lithium borate (Li₂B₄O₇), a potassium niobate (KNbO₃), a langasite crystal (La₃Ga₅SiO₁₄), and a langanite (La₃Nb_{0.5}Ga_{5.5}O₁₄), a resonance circuit having a ceramic resonator, and an LC resonance circuit. The quartz-crystal resonator is selected because of its precision and stability.

FIG. 4 shows a modified example of the circuit configuration of the transponder 10. The transponder 10 includes a MOSFET 33 as a switching element. In the circuit configuration of the transponder 10 shown in FIG. 4, the fact that a MOSFET 33 instead of the diode 10 shown in FIG. 1 is connected and the resistor 21 constituting the pressure measuring unit shown in FIG. 1 is omitted is different from the circuit configuration in the transponder 10 shown in FIG. 1. When the MOSFET 33 is used instead of the diode 10, when the capacitor 29 charges to a certain amount with response of the resonance circuit 30, the MOSFET 33 turns ON. Consequently, the tire pressure which is detected by the pressure measuring unit 20 influences the resonance frequency of the quartz-crystal resonator 16, thereby obtaining the same function and effect as the above-described embodiment.

What is claimed is:

1. A tire information detecting device, comprising:
a measured value transmitter mounted in a tire of a vehicle;
a controller disposed in a main body of the vehicle configured to transmit and receive a signal to and from the measured value transmitter;
the measured value transmitter including an antenna, a modulator and a demodulator, configured to transmit and receive the signal to and from the controller,
a pressure measuring unit that measures a tire pressure;
a detecting resonance circuit connected between the modulator and the pressure measuring unit, the resonance circuit resonating in response to the signal from die controller;
a connecting resonance circuit configured to resonate in response to the signal from the controller; and
a control circuit configured to control a connection between the pressure measuring unit and the detecting resonance circuit.

2. The tire information detecting device according to claim 1, wherein the control circuit includes a switching element connected to an input-output terminal of the pressure measuring unit on a first signal line, and the pressure measuring unit connected to the detecting resonance circuit by turning on the switching element at the time of resonance of the connecting resonance circuit, wherein the pressure measuring unit is disconnected from the detecting resonance circuit by turning off the switching element at the time of non-resonance of the connecting resonance circuit.

3. The tire information detecting device according to claim 2, wherein the measured value transmitter is operable to transmit a signal of a resonance frequency of the detecting resonance circuit to the controller when the switching element is turned off, and transmit a signal of a resonance frequency of the detecting resonance circuit in accordance with the measurement result of the pressure measuring unit to the controller when the switching element is turned on.

4. The tire information detecting device according to claim 2, wherein the measured value transmitter includes a second signal line configured to bypasses the first signal line between an input-output terminal of the modulator and an input-output terminal of the switching element.

5. The tire information detecting device according to claim 1, wherein the connecting resonance circuit includes an IX resonance circuit.

6. The tire information detecting device according to claim 1, wherein the connecting resonance circuit includes a piezoelectric resonator.

7. The tire information detecting device according to claim 2, wherein the switching element includes a diode.

8. The tire information detecting device according to claim 2, wherein the switching element includes a field-effect transistor.

9. The tire information detecting device according to claim 1, wherein the controller is operable to:
transmit a signal to permit the detecting resonance circuit and the connecting resonance circuit to resonate to the measured value transmitter,
receive a signal of a resonance frequency of the detecting resonance circuit and a signal of a resonance frequency of the detecting resonance circuit in accordance with the measurement result of the pressure measuring unit from the measured value transmitter; and
calculate a temperature and a pressure of the tire based on the resonance frequency of the detecting resonance circuit extracted from the received signal.

10. The tire information detecting device according to claim 9, wherein the controller is operable to calculate the temperature of the tire based on a difference in frequency between the frequency at signal that allows the detecting resonance circuit to resonate and the resonance frequency extracted from the received signal in response to the signal.

11. The tire information detecting device according to claim 9, wherein the controller is operable to calculate the pressure of the tire based on a difference in frequency between the resonance frequency extracted from the received signal and the resonance frequency extracted from the received signal in response to the signal that allows the detecting resonance circuit to resonate in accordance with the measurement result of the pressure measuring unit.

12. The tire information detecting device according to claim 1, wherein the detecting resonance circuit includes a quartz-crystal resonator.
